(19) United States
(12) Patent Application Publication
(10) Pub. No.: US 2026/0253157 A1
(43) Pub. Date: Aug. 27, 2026

(54) NEGOTIATION SYSTEM, NEGOTIATION METHOD, AND NON-TRANSITORY COMPUTER READABLE MEDIUM

(71) Applicant: NEC Corporation, Tokyo (JP)

(72) Inventors: Tomohito ANDO, Tokyo (JP); Satoshi MORINAGA, Tokyo (JP)

(73) Assignee: NEC Corporation, Tokyo (JP)

(21) Appl. No.: 19/162,189

(22) PCT Filed: Mar. 16, 2023
(86) PCT No.: PCT/JP2023/010324

§ 371 Date: Sep. 4, 2025

(51) Int. Cl. G06Q 50/18

(52) U.S. Cl. CPC G06Q 50/188

(57) ABSTRACT

In order to solve the problem of reducing the possibility that a negotiation ends up in a failure to reach an agreement, a negotiation system includes: an agreement-candidate-plan acquisition unit that acquires a first agreement candidate plan provided from a negotiating entity in a negotiation with the negotiating entity, the negotiating entity being the other party involved in the negotiation; a concession-status-information acquisition unit that acquires concession status information indicating the status of concession of the negotiating entity in the first agreement candidate plan; and a response unit that executes processing for responding to the first agreement candidate plan in accordance with the status of concession indicated by the concession status information.

### TECHNICAL FIELD

The present invention relates to a technology for performing a negotiation.

### BACKGROUND ART

PTL 1 describes a technology in which an inference unit transmits a proposal to another inference unit, and in a case where the proposal is rejected by the another inference unit, a negotiation is performed by transmitting a next proposal to the another inference unit.

### CITATION LIST

### Patent Literature

PTL 1: JP 10-161877 A

### SUMMARY OF INVENTION

### Technical Problem

Here, there is a case where a negotiation subject (for example, a person or the like) participating in a negotiation tends to give up the negotiation, in a case where a proposal from another party largely deviates from a proposal in which the negotiation subject has made a maximum concession. There has been a problem in that, in a case of negotiating with the negotiation subject having such a tendency, the inference unit described in PTL 1 cannot reduce a possibility that the negotiation ends in disagreement.

One aspect of the present invention has been made in view of the above problem, and an example of an object of the present invention is to provide a technology for reducing a possibility that a negotiation ends in disagreement.

### Solution to Problem

A negotiation system according to one aspect of the present invention includes agreement candidate proposal acquisition means for acquiring a first agreement candidate proposal provided from a negotiation subject, in a negotiation with the negotiation subject that is a negotiation partner, concession status information acquisition means for acquiring concession status information indicating a concession status of the negotiation subject in the first agreement candidate proposal, and response means for executing processing for responding to the first agreement candidate proposal, according to the concession status indicated by the concession status information.

A negotiation method, executed by one or more processors, according to one aspect of the present invention includes acquiring a first agreement candidate proposal provided from a negotiation subject, in a negotiation with the negotiation subject that is a negotiation partner, acquiring concession status information indicating a concession status of the negotiation subject in the first agreement candidate proposal, and executing processing for responding to the first agreement candidate proposal, according to the concession status indicated by the concession status information.

A program according to one aspect of the present invention for causing a computer to function as agreement candidate proposal acquisition means for acquiring a first agreement candidate proposal provided from a negotiation subject, in a negotiation with the negotiation subject that is a negotiation partner, concession status information acquisition means for acquiring concession status information indicating a concession status of the negotiation subject in the first agreement candidate proposal, and response means for executing processing for responding to the first agreement candidate proposal, according to the concession status indicated by the concession status information.

### Advantageous Effects of Invention

According to one aspect of the present invention, it is possible to reduce a possibility that a negotiation ends in disagreement.

### BRIEF DESCRIPTION OF DRAWINGS

FIG. 1 is a block diagram illustrating a configuration of a negotiation system according to a first example embodiment of the present invention.

FIG. 2 is a flowchart illustrating a flow of a negotiation method according to the first example embodiment of the present invention.

FIG. 3 is a block diagram illustrating a configuration of a negotiation system according to a second example embodiment of the present invention.

FIG. 4 is a block diagram illustrating a functional configuration of a negotiation device according to the second example embodiment of the present invention.

FIG. 5 is a block diagram illustrating an example of a functional configuration of another negotiation device according to the second example embodiment of the present invention.

FIG. 6 is a flowchart illustrating a flow of a negotiation method according to the second example embodiment of the present invention.

FIG. 7 is a diagram illustrating a screen example including an agreement candidate proposal, presented in the second example embodiment of the present invention.

FIG. 8 is a diagram illustrating a screen example on which the agreement candidate proposal and concession status information presented in the second example embodiment of the present invention can be input.

FIG. 9 is a diagram illustrating a screen example on which a providing reason presented in the second example embodiment of the present invention is input.

FIG. 10 is a diagram illustrating a screen example including recommendation information, presented in the second example embodiment of the present invention.

FIG. 11 is a diagram illustrating a screen example including a new agreement candidate proposal, presented in the second example embodiment of the present invention.

FIG. 12 is a diagram illustrating a screen example on which the new agreement candidate proposal and the concession status information presented in the second example embodiment of the present invention can be input.

FIG. 13 is a block diagram illustrating the configuration of the negotiation device according to a modified example of the second example embodiment of the present invention.

FIG. 14 is a block diagram illustrating the configuration of the negotiation system according to another modified example of the second example embodiment of the present invention.

FIG. 15 is a diagram illustrating a hardware configuration example of each device in each example embodiment of the present invention.

### Example Embodiment

In the following description, a “negotiation subject” indicates, for example, a subject having an ability for generating an agreement candidate proposal to be provided to another negotiation subject and an ability for determining whether to agree with an agreement candidate proposal acquired from the another negotiation subject. The negotiation subject may be a device, a person, or an organization. The “negotiation device” indicates, for example, a device that functions as the negotiation subject. There is a case where “negotiation device” indicates, for example, a device that functions based on an operation of a person who is the negotiation subject or a person belonging to an organization that is the negotiation subject. A computer, a robot, a drone, an autonomous vehicle, and the like are examples of the negotiation device. For example, the “negotiation” indicates that the negotiation subjects alternately provide agreement candidate proposals, until an agreement is built between the negotiation subjects. The negotiation may be a negotiation between subjects having conflicting interests or a negotiation (adjustment) between subjects having no conflicting interests.

In the following description, it is assumed that two-party negotiation is performed by two negotiation subjects sharing a set of agreement candidate proposals. However, this assumption is for convenience of description, and a multi-party negotiation by three or more negotiation subjects is included in the scope of the present invention.

### First Example Embodiment

A first example embodiment of the present invention will be described in detail with reference to the drawings. The present example embodiment is a basic form of the example embodiment described below.

### Configuration of Negotiation System 1

A configuration of a negotiation system 1 according to the present example embodiment will be described with reference to FIG. 1. FIG. 1 is a block diagram illustrating the configuration of the negotiation system 1. As illustrated in FIG. 1, the negotiation system 1 includes an agreement candidate proposal acquisition unit 11, a concession status information acquisition unit 12, and a response unit 13. The agreement candidate proposal acquisition unit 11 is an example of a configuration that achieves agreement candidate proposal acquisition means described in claims. The concession status information acquisition unit 12 is an example of a configuration that achieves concession status information acquisition means described in claims. The response unit 13 is an example of a configuration that achieves response means described in claims. The agreement candidate proposal acquisition unit 11 acquires a first agreement candidate proposal provided by a negotiation subject, in a negotiation with the negotiation subject that is a negotiation partner. The concession status information acquisition unit 12 acquires concession status information indicating a concession status of the negotiation subject in the first agreement candidate proposal. The response unit 13 executes processing for responding to the first agreement candidate proposal, in accordance with the concession status indicated by the concession status information.

### Implementation Example by Program

In a case where the negotiation system 1 includes a computer including a processor and a memory, the memory stores the following program according to the present example embodiment. The program causes the computer to function as the agreement candidate proposal acquisition unit 11 that acquires the first agreement candidate proposal provided from the negotiation subject, in the negotiation with the negotiation subject that is the negotiation partner, the concession status information acquisition unit 12 that acquires the concession status information indicating the concession status of the negotiation subject in the first agreement candidate proposal, and the response unit 13 that executes the processing for responding to the first agreement candidate proposal, according to the concession status indicated by the concession status information.

### Flow of Negotiation Method S1

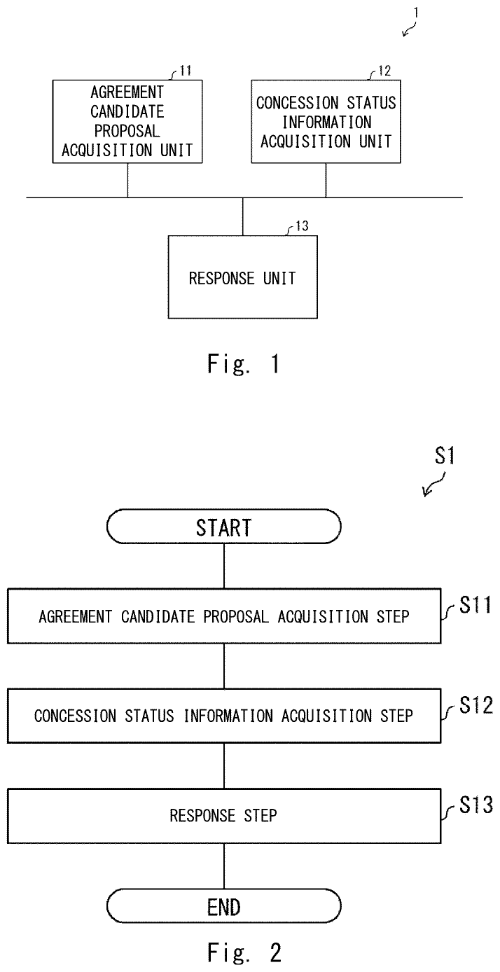

The negotiation system 1 configured as described above executes a negotiation method S1 according to the present example embodiment. A flow of the negotiation method S1 will be described with reference to FIG. 2. FIG. 2 is a flowchart illustrating the flow of the negotiation method S1. As illustrated in FIG. 2, the negotiation method S1 is a method in which one or more processors included in the negotiation system 1 execute steps S11, S12, and S13.

In step S11, the one or more processors acquire the first agreement candidate proposal provided from the negotiation subject, in the negotiation with the negotiation subject that is the negotiation partner. In step S12, the one or more processors acquire the concession status information indicating the concession status of the negotiation subject in the first agreement candidate proposal. In step S13, the one or more processors execute the processing for responding to the first agreement candidate proposal, according to the concession status indicated by the concession status information.

### Effects of Present Example Embodiment

As described above, in the present example embodiment, a configuration is adopted for acquiring the first agreement candidate proposal provided from the negotiation subject, in the negotiation with the negotiation subject that is the negotiation partner, acquiring the concession status information indicating the concession status of the negotiation subject in the first agreement candidate proposal, and executing the processing for responding to the first agreement candidate proposal, according to the concession status indicated by the concession status information. Therefore, according to the present example embodiment, an effect of reducing a possibility that a negotiation ends in disagreement can be obtained.

### Second Example Embodiment

A second example embodiment of the present invention will be described in detail with reference to the drawings. Components having the same functions as the components described in the first example embodiment are denoted by the same reference signs, and the description thereof will be appropriately omitted.

### Configuration of Negotiation System 1A

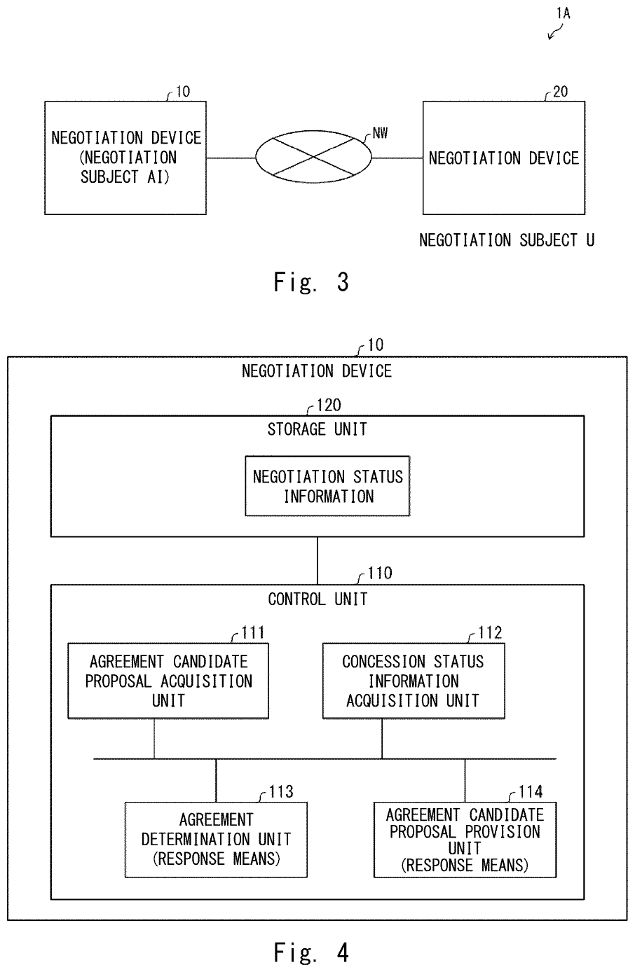

FIG. 3 is a block diagram illustrating a configuration of a negotiation system 1A according to the present example embodiment. As illustrated in FIG. 3, the negotiation system 1A includes a negotiation device 10 and a negotiation device 20. The negotiation device 10 and the negotiation device 20 are communicably connected to each other via a network NW.

The negotiation device 10 functions as a negotiation subject AI that negotiates with another negotiation subject without depending on a user's operation. The negotiation device 20 is a device used by a negotiation subject U that is a person or an organization to negotiate with another negotiation subject. The negotiation device 20 has a function for negotiating with the another negotiation subject based on an operation of the person who is the negotiation subject U (or an operation of a person belonging to an organization that is the negotiation subject U). The negotiation subject U is an example of a “negotiation subject” described in claims.

### Configuration of Negotiation Device 10

FIG. 4 is a block diagram illustrating a functional configuration of the negotiation device 10. As illustrated in FIG. 4, the negotiation device 10 includes a control unit 110 and a storage unit 120. The control unit 110 integrally controls each unit of the negotiation device 10. The control unit 110 includes an agreement candidate proposal acquisition unit 111, a concession status information acquisition unit 112, an agreement determination unit 113, and an agreement candidate proposal provision unit 114. The storage unit 120 stores various types of data used by the control unit 110. The various types of data stored in the storage unit 120 include negotiation status information.

The agreement candidate proposal acquisition unit 111 receives an agreement candidate proposal U provided from the negotiation subject U, from the negotiation device 20. The agreement candidate proposal U is an example of a “first agreement candidate proposal” described in claims.

The concession status information acquisition unit 112 receives concession status information indicating a concession status of the negotiation subject U in the agreement candidate proposal U, from the negotiation device 20. In a case of acquiring a reason for providing the agreement candidate proposal U, as the concession status information, the concession status information acquisition unit 112 estimates the concession status according to the providing reason. In a case of acquiring information indicating that the agreement candidate proposal U is a final proposal, as the concession status information, the concession status information acquisition unit 112 applies a concession status that “the concession status is maximized” associated with “the final proposal”.

The agreement determination unit 113 executes processing for determining whether to agree with the agreement candidate proposal U, according to the concession status indicated by the concession status information. The “determining processing” is included in “responding processing” described in claims. The agreement determination unit 113 is an example of a configuration that achieves “response means” described in claims. For example, the agreement determination unit 113 executes the processing for determining whether to agree with the agreement candidate proposal U, based on whether a utility of a negotiation subject AI side obtained from the agreement candidate proposal U is larger than a threshold. The agreement determination unit 113 uses a smaller threshold as a degree of a concession indicated by the concession status information is larger, as the threshold. The utility of the negotiation subject AI side is calculated by using a utility function used to calculate a utility for the negotiation subject AI from any agreement candidate proposal. Hereinafter, the utility of the negotiation subject AI side is also described as a utility AI.

In a case of not agreeing with the agreement candidate proposal U, the agreement candidate proposal provision unit 114 executes processing for providing an agreement candidate proposal AI according to the concession status indicated by the concession status information, to the negotiation subject. The agreement candidate proposal AI is an example of a “second agreement candidate proposal” described in claims. The “providing processing” is included in the “responding processing” described in claims. The agreement candidate proposal provision unit 114 is an example of a configuration that achieves the “response means” described in claims. For example, the agreement candidate proposal provision unit 114 provides a second agreement candidate proposal of which an obtained utility AI is smaller or an estimated utility of the negotiation subject U side is larger, as the degree of the concession indicated by the concession status information is larger. The utility of the negotiation subject U side is calculated by using a utility function used to estimate a utility for the negotiation subject U from any agreement candidate proposal. Hereinafter, the utility of the negotiation subject U side is also described as a utility U.

### Negotiation Status Information

The negotiation status information stored in the storage unit 120 will be described. The negotiation status information is information indicating a status of a negotiation. For example, the negotiation status information is associated with identification information used to identify a negotiation. The negotiation status information associated with the identification information of the negotiation is also described as negotiation status information of the negotiation. The negotiation status information may include a history of agreement candidate proposals shared in the negotiation. In a case where the negotiation has already ended, the negotiation status information may further include a result of the negotiation. The result of the negotiation indicates a final agreement, a final disagreement, cancellation of the negotiation, or the like. The negotiation status information is appropriately referred to in processing for determining an agreement by the agreement determination unit 113. The negotiation status information is appropriately referred to in processing for generating the agreement candidate proposal AI by the agreement candidate proposal provision unit 114.

### Concession Status and Concession Status Information

The concession status of the negotiation subject U in the agreement candidate proposal U represents a degree of a concession made by the negotiation subject U in generating the agreement candidate proposal U. In the present example embodiment, as the degree of the concession, two stages of whether “to make a maximum concession” are applied. However, the concession status is not limited to the above example.

The concession status information is information indicating the concession status of the negotiation subject U. There is a case where the concession status information is added to the agreement candidate proposal U and is transmitted from the negotiation device 20 to the negotiation device 10. In addition, there is a case where the concession status information is transmitted from the negotiation device 20 to the negotiation device 10 without being added to the agreement candidate proposal U. In the latter case, the concession status information indicates a concession status in the agreement candidate proposal U most recently transmitted from the negotiation device 20 to the negotiation device 10.

The concession status information may be, for example, information directly indicating the concession status and may be information indirectly indicating the concession status. As an example of the information directly indicating the concession status, “information indicating that it is a final proposal” is exemplified. The “information indicating that it is the final proposal” is associated with the concession status in which “the maximum concession is made” in the agreement candidate proposal U and directly indicates the concession status. However, the information directly indicating the concession status is not limited to the above example.

The information indirectly indicating the concession status is information referred to estimate the concession status, and the reason for providing the agreement candidate proposal U is exemplified, as an example. For example, it is assumed that another negotiation Y related to a negotiation X between the negotiation subjects U and AI be made between the negotiation subject U and another negotiation subject. In addition, it is assumed that a negotiation status of the negotiation Y affect agreement building in the negotiation X. In this case, as an example of the “providing reason”, a reason including the negotiation status of the negotiation Y is exemplified. There is a case where the concession status can be estimated, based on the effect of the negotiation status of the negotiation Y on the agreement building in the negotiation X. In other words, such a providing reason is an example of the information referred to estimate the concession status. However, the information indirectly indicating the concession status is not limited to the above example.

### Configuration of Negotiation Device 20

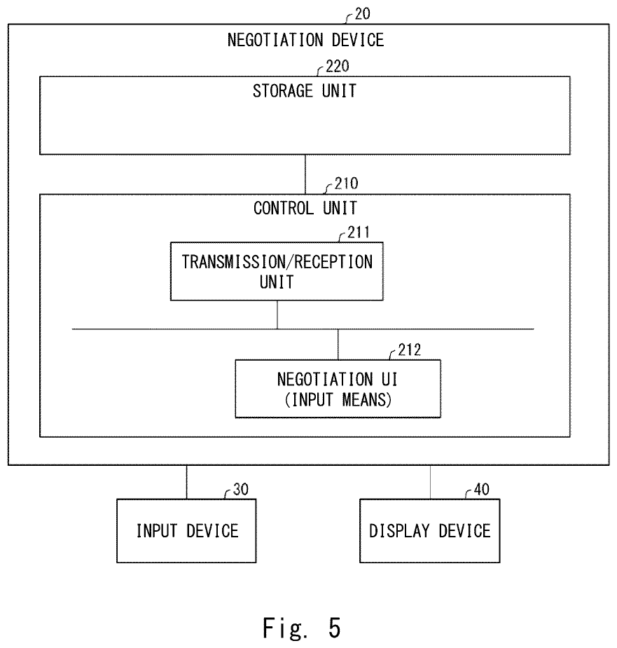

FIG. 5 is a block diagram illustrating an example of a functional configuration of the negotiation device 20. As illustrated in FIG. 5, the negotiation device 20 includes a control unit 210 and a storage unit 220. The negotiation device 20 is connected to an input device 30 and a display device 40. The control unit 210 integrally controls each unit of the negotiation device 20. The control unit 210 includes a transmission/reception unit 211 and a negotiation user interface (hereinafter, described as a negotiation UI) 212. The negotiation UI 212 is an example of a configuration that achieves input means described in claims. The storage unit 220 stores various types of data used by the control unit 210.

The transmission/reception unit 211 transmits the agreement candidate proposal U and the concession status information to the negotiation device 10 and receives the agreement candidate proposal AI from the negotiation device 10.

The negotiation UI 212 displays the agreement candidate proposal AI on the display device 40. The negotiation UI 212 receives an operation for inputting the agreement candidate proposal U. The negotiation UI 212 receives an operation for inputting the concession status information, from the negotiation subject U. For example, the negotiation UI 212 may receive input of (1) the information indicating the providing reason of the agreement candidate proposal U or (2) the information indicating that the agreement candidate proposal U is the final proposal, as the concession status information. Here, the “final proposal” is a proposal with the lowest utility U of the negotiation subject U side or a proposal with the highest utility AI estimated by the negotiation subject U, among one or the plurality of agreement candidate proposals U considered to be provided to the negotiation subject AI by the negotiation subject U. However, whether the “utility U is the lowest” or whether “the utility AI is the highest” depends on subjective determination by the negotiation subject U. Therefore, there is not necessarily no agreement candidate proposal with the smaller utility U than the “final proposal”, and in addition, there is not necessarily no agreement candidate proposal with the higher utility AI than the “final proposal”.

For example, the negotiation UI 212 may receive an input of an instruction to switch the negotiation made with the negotiation subject U to a negotiation made with an operator. For example, in a case where the input of the instruction is received, the transmission/reception unit 211 transmits information indicating the instruction to the negotiation device 10. In a case where the instruction is input, the negotiation UI 212 may output information for recommending to input the concession status information and to continue the negotiation.

### Flow of Negotiation Method S2

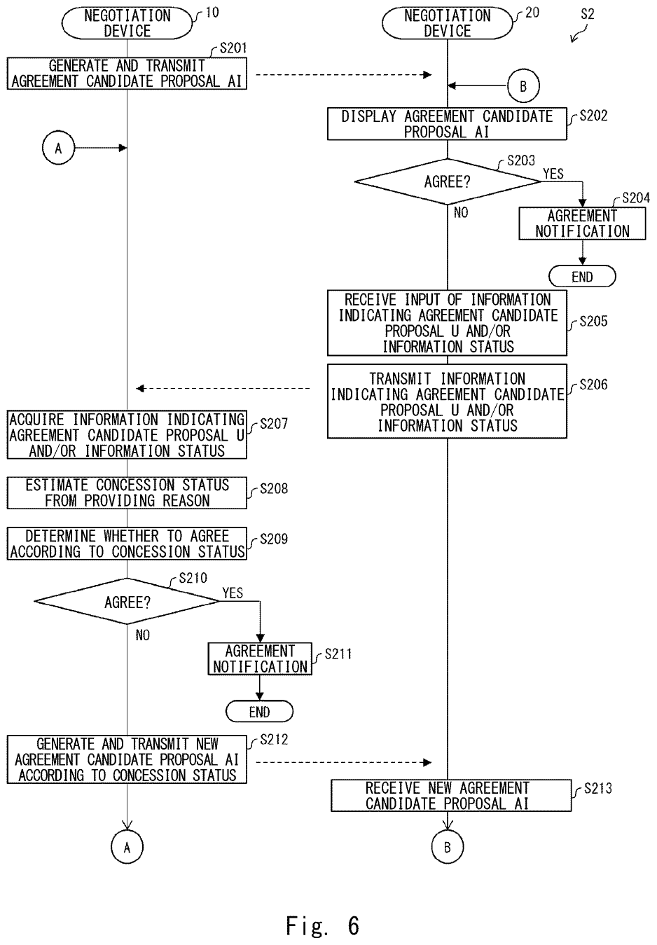

The negotiation system 1A configured as described above executes a negotiation method S2 according to the present example embodiment. FIG. 6 is a flowchart illustrating a flow of the negotiation method S2. As illustrated in FIG. 6, the negotiation method S2 includes steps S201 to S213.

### (Steps S201 and S202)

In step S201, the agreement candidate proposal provision unit 114 of the negotiation device 10 (the negotiation subject AI) generates the agreement candidate proposal AI and transmits the agreement candidate proposal AI to the negotiation device 20 (used by the negotiation subject U). In step S202, the transmission/reception unit 211 of the negotiation device 20 receives the agreement candidate proposal AI. The negotiation UI 212 displays the agreement candidate proposal AI on the display device 40. As a result, the agreement candidate proposal AI is presented to the negotiation subject U.

### (Screen Example in Step S202)

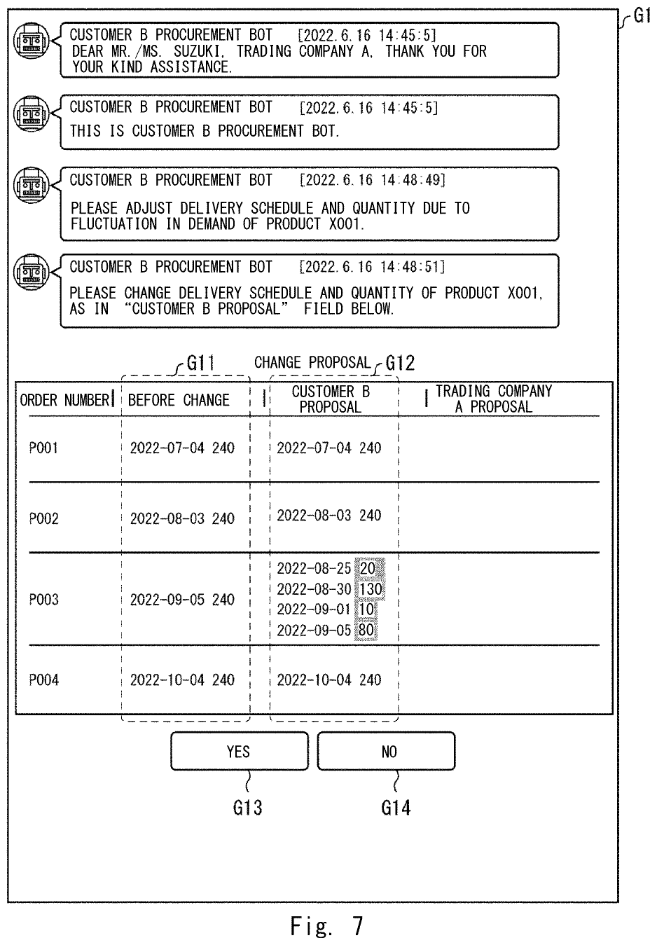

FIG. 7 is a diagram illustrating a screen example Gl including the agreement candidate proposal AI presented in step S202.

In this example, as the negotiation in the present example embodiment, the negotiation X regarding acceptance and order of products is applied. Specifically, the negotiation X is a negotiation for changing a delivery schedule of a product X001 ordered to a trading company A from a customer B, as desired by the customer B. Here, as an example, as the negotiation subject U that uses the negotiation device 20, a person in charge in the trading company A that sells the products is applied. For example, as the negotiation subject AI (the negotiation device 10), a customer B bot that functions as a proxy of the customer B who purchases the product is applied.

The screen example G1 includes a delivery schedule before change G11 and a customer B proposal G12. The delivery schedule before change G11 is information currently scheduled for the product X001 ordered from the customer B to the trading company A. The delivery schedule G11 includes a delivery date and a quantity of each of orders (order numbers P001 to P004). The customer B proposal G12 is an example of an agreement candidate proposal AI generated by the customer B bot. The customer B proposal G12 has content in which a delivery date “2022 September 05” and a quantity “240” of the order number P003 included in the delivery schedule before change G11 to a delivery date and a quantity of each time in the case where the order number P003 is divided and delivered into four times. In the screen example G1, an operation object G13 (“Yes” button) receives an operation indicating that the customer B proposal G12 that is the agreement candidate proposal AI is agreed. An operation object G14 (“No” button) receives an operation indicating that the customer B proposal G12 is not agreed.

### (Steps S203 to S206)

Step S203 will be described again with reference to FIG. 6. In step S203, the negotiation UI 212 determines whether to agree with the agreement candidate proposal AI, based on the operation of the negotiation subject U. For example, in the example in FIG. 7, in a case where the operation object G13 is operated, the negotiation UI 212 determines to agree with the agreement candidate proposal AI. For example, in a case where the operation object G14 is operated, the negotiation UI 212 determines not to agree with the agreement candidate proposal AI.

In a case where it is determined to agree with the agreement candidate proposal AI (Yes in step S203), step S204 is executed. In step S204, the transmission/reception unit 211 transmits information indicating to agree with the agreement candidate proposal AI, to the negotiation device 10. Then, the negotiation system 1A ends the negotiation method S2.

In a case where it is determined not to agree with the agreement candidate proposal AI (No in step S203), step S205 is executed. In step S205, the negotiation UI 212 receives an operation for inputting one or both of the agreement candidate proposal U and the concession status information, from the negotiation subject U. In a case where both of the agreement candidate proposal and the concession status information are input, both pieces of information may be described as “the agreement candidate proposal to which the concession status information is added”. The agreement candidate proposal U is a counter offer for the agreement candidate proposal AI. As the agreement candidate proposal U, a proposal with the larger utility U obtained from the agreement candidate proposal U than the utility U obtained from the agreement candidate proposal AI is input by the negotiation subject U. As the concession status information, as described above, the providing reason, the information indicating that it is the final proposal, or a combination of some or all of these is input. The concession status information is not necessarily input, and there is a case where only the agreement candidate proposal U is input. In a case where the agreement candidate proposal U has already been transmitted to the negotiation device 10, there is a case where the agreement candidate proposal U is not input and only the concession status information is input.

In step S206, the transmission/reception unit 211 transmits one or both of the agreement candidate proposal U and the concession status information, to the negotiation device 10.

### (Screen Example in Step S205)

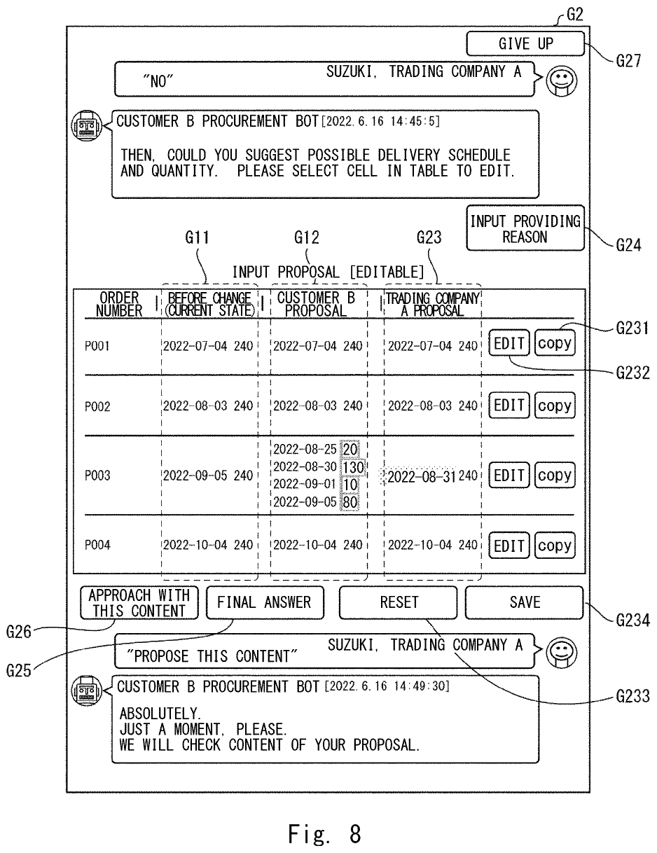

FIG. 8 is a diagram illustrating a screen example G2, on which the agreement candidate proposal U (a trading company A proposal G23) and the concession status information can be input, presented in step S205. The screen example G2 is displayed on the display device 40 following the screen example G1 illustrated in FIG. 7. Specifically, in a case where the operation object G14 (“No” button) is operated in the screen example G1, the screen example G1 may be switched to the screen example G2 and the screen example G2 may be displayed, or the screen example G1 may be scrolled upward and the screen example G2 may be added and displayed below.

The screen example G2 includes the delivery schedule before change G11, the customer B proposal G12, and the trading company A proposal G23. The delivery schedule before change G11 and the customer B proposal G12 are similar to those displayed on the screen example G1. The trading company A proposal G23 is a counter offer for the customer B proposal G12 and can be edited by an operation of the person in charge in the trading company A for operation objects G231 to G234. The operation objects G231 and G232 are displayed for each of the orders (order numbers P001 to P004) included in the customer B proposal G12.

The operation object G231 (“COPY” button) receives an operation for replicating the delivery schedule of the order in the customer B proposal. When the operation for the operation object G231 is received, the delivery date and the quantity regarding the order in the customer B proposal are replicated as initial values of the delivery schedule of the order in the trading company A proposal G23. The operation object G232 (“edit” button) receives an operation for switching the delivery schedule regarding the order in the trading company A proposal G23 into an edition mode. When the operation for the operation object G232 is received, an operation for changing the delivery date and the quantity of the order in the trading company A proposal G23 becomes possible. Here, the trading company A proposal G23 is changed from delivery dates and quantities for four times of the order number P003 included in the customer B proposal G12 to a delivery date “2022 August 31” and a quantity “240” for one time, by the operation of the person in charge in the trading company A. Although the delivery date “2022 August 31” is later than the earliest delivery date “2022 August 25” among the delivery dates for four times of the order number P003 included in the customer B proposal G12, the delivery date “2022 August 31” is a date earlier than a delivery date “2022 September 05” of the order number P0003 in the delivery schedule before change G11. That is, the trading company A proposal G23 has a smaller utility U than the delivery schedule G11 for the trading company A, has a larger utility U than the customer B proposal G12, and is created by a concession of the person in charge in the trading company A.

The operation object G233 (“reset” button) receives an operation for resetting an editing operation in the trading company A proposal G23. When the operation for the operation object G233 is received, the trading company A proposal G23 is reset to a state before being edited (blank or a state at the time of previous saving). The operation object G234 (“save” button) receives an operation for saving the trading company A proposal G23. When the operation for the operation object G234 is received, information indicating the trading company A proposal G23 is stored in the storage unit 220 and can be called at a later date.

The screen example G2 includes operation objects G24 to G26 used to transmit one or both of the concession status information and the trading company A proposal G23. As an example, the operation object G24 (“input providing reason” button) receives an operation for inputting the providing reason of the trading company A proposal G23 (an example of the concession status information). The operation object G25 (“final answer” button) receives an operation for transmitting the information indicating that the trading company A proposal G23 is the final proposal (an example of the concession status information) and the trading company A proposal G23 to the customer B bot. In a case where the providing reason is input, the operation object G26 (“approach with this content” button) receives an operation for transmitting the providing reason (an example of the concession status information) and the trading company A proposal G23 to the customer B bot. In a case where the providing reason is not input, the operation object G26 (“approach with this content” button) receives an operation for transmitting the trading company A proposal G23 to the customer B bot. When any one of the operation objects G24 to G26 is operated, one or both of the trading company A proposal G23 and the concession status information are transmitted to the customer B bot. An operation object G27 (“give up” button) receives an instruction for giving up the negotiation X with the customer B bot and switching to a negotiation with an operator.

### (Specific Example 1 of Input and Transmission of Concession Status Information)

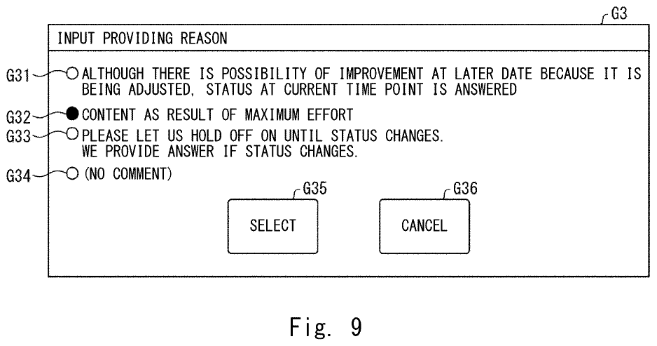

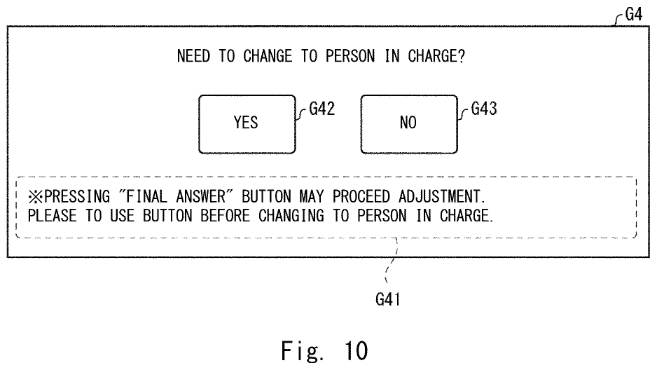

As a specific example of input and transmission of the concession status information on the screen example G 2, a specific example 1 for inputting and transmitting the providing reason will be described. FIG. 9 is a diagram illustrating a screen example G3 on which the providing reason is input. The screen example G3 is displayed on the display device 40 following the screen example G2 in a case where the operation object G24 is operated on the screen example G2. Specifically, the screen example G2 may be switched to the screen example G3 and the screen example G3 may be displayed, and the screen example G2 may be scrolled upward and the screen example G3 may be added and displayed below. In addition, the screen example G3 may be displayed by being superimposed on the screen example G2 as a dialogue.

The screen example G3 includes providing reasons G31 to G34 and operation objects G35 and G36. The providing reasons G31 to G34 receive an operation for selecting any one of them. The operation object G35 (“confirm” button) receives an operation for determining a selection operation for the providing reasons G31 to G34. In a case where the operation for the operation object G35 is received, the negotiation UI 212 temporarily stores the providing reason G32 selected from among the providing reasons G31 to G34 in the storage unit 220 as the concession status information.

The operation object G36 (“cancel” button) receives an operation for canceling the selection operation on the providing reasons G31 to G34. In a case where the operation for the operation object G36 is received, the negotiation UI 212 does not store the providing reason in the storage unit 220, even if any one of the providing reasons G31 to G34 has been selected.

In a case where the operation for the operation objects G35 and G36 is received, the screen example G2 is displayed subsequent to the screen example G3. Specifically, the screen example G3 may be switched to the screen example G2 and the screen example G2 may be displayed, and the screen example G3 may be scrolled upward and the screen example G2 may be added and displayed below. In a case where the screen example G3 is displayed as the dialogue, the screen example G2 may be displayed by hiding the screen example G3.

In the present specific example, after editing the trading company A proposal G23 on the screen example G2, the person in charge in the trading company A performs an operation for selecting the providing reason G32 “content as a result of a maximum effort” on a screen example G5 and operates the operation object G35 (“confirm” button). Thereafter, the person in charge in the trading company A operates the operation object G26 (“approach with this content” button) on the screen example G2. As a result, the transmission/reception unit 211 transmits the trading company A proposal G23 to which the providing reason G32 “content as a result of a maximum effort” stored in the storage unit 220 is added as the concession status information, to the customer B bot.

### (Specific Example 2 of Input and Transmission of Concession Status Information)

As another specific example of the input and the transmission of the concession status information on the screen example G 2, a specific example 2 for transmitting information indicating that it is the final proposal will be described. In this specific example, after editing the trading company A proposal G23 on G4, the person in charge in the trading company A operates the operation object G25 (“final answer” button). As a result, the transmission/reception unit 211 transmits the trading company A proposal G23 to which the concession status information indicating that it is the final proposal is added, to the customer B bot.

(“Give up” Button)

By operating the operation object G27 (“give up” button) on the screen example G2, the person in charge in the trading company A can give up the negotiation X with the customer B bot and issue an instruction to switch the negotiation X to the negotiation with the operator. For example, the person in charge in the trading company A may operate the operation object G27 (“give up” button), without editing the trading company A proposal G23. In a case where the operation for the operation object G27 (“give up” button) is received, the transmission/reception unit 211 may transmit information for instructing to switch the negotiation to the negotiation with the operator, to the customer B bot. In a case of receiving the instructing information, for example, the customer B bot may execute processing for switching the negotiation to a negotiation with a person in charge in the customer B who is a person.

(Modified Example of “give up” Button)

Here, a modified example of the operation object G27 (“give up” button) will be described. For example, in a case where the operation for the operation object G27 (“give up” button) is received, the negotiation UI 212 may display information for recommending to input the concession status information and to continue the negotiation X with the customer B bot.

FIG. 10 is a diagram illustrating a screen example G4 including the recommending information. Specifically, the screen example G2 may be switched to the screen example G4 and the screen example G4 may be displayed, and the screen example G2 may be scrolled upward and the screen example G4 may be added and displayed below. In addition, the screen example G4 may be displayed by being superimposed on the screen example G2 as a dialogue. The screen example G4 includes recommendation information G41 and operation objects G42 and G43. The recommendation information G41 is an example of “the information for recommending to input the concession status information and to continue the negotiation X with the customer B bot”, and includes information for recommending the operation for the operation object G25 (“final answer” button). In a case where the operation object G42 (“Yes” button) is operated, the transmission/reception unit 211 transmits the information indicating the instruction to switch the negotiation to the negotiation with the person in charge in the customer B, to the customer B bot. In a case where the operation object G43 (“No” button) is operated, the information indicating the instruction is not transmitted, and the screen example G2 is displayed subsequent to the screen example G4.

Specifically, the screen example G4 may be switched to the screen example G2 and the screen example G2 may be displayed, and the screen example G4 may be scrolled upward and the screen example G2 may be added and displayed below. In a case where the screen example G4 is displayed as the dialogue, the screen example G4 may be displayed by hiding the screen example G4.

For example, after visually recognizing the recommendation information G41 on the screen example G4, the person in charge in the trading company A may operate the operation object G43 (“No” button) and return to the screen example G2 and operate the operation object G25 (“final answer” button).

### (Steps S207 to S211)

Step S207 and subsequent steps will be described with reference to FIG. 6 again. In step S207, the agreement candidate proposal acquisition unit 111 of the negotiation device 10 receives the agreement candidate proposal U from the negotiation device 20. The concession status information acquisition unit 112 receives the concession status information from the negotiation device 20. As described above, one of the agreement candidate proposal U and the concession status information may be received.

Step S208 is a step executed in a case where the providing reason is received as the concession status information. The concession status information acquisition unit 112 estimates the concession status with reference to the providing reason. For example, the concession status information acquisition unit 112 may estimate the concession status that “the maximum concession is made”, with reference to the providing reason G32 “content as a result of a maximum effort”. For example, the concession status information acquisition unit 112 may estimate a concession status of “it cannot be said that maximum concession is made”, with reference to the providing reason G31 “although there is a possibility of improvement at later date because it is being adjusted, a status at a current time point is answered”. In a case where the providing reason is not received as the concession status information, the step is omitted.

In step S209, the agreement determination unit 113 determines whether to agree with the agreement candidate proposal U, according to the concession status indicated by the concession status information. Specifically, the agreement determination unit 113 sets a smaller threshold as the degree of the concession indicated by the concession status information is larger, as a threshold to be compared with the utility AI obtained from the agreement candidate proposal U. For example, in a case where the concession status information indicates that “the maximum concession is made”, the agreement determination unit 113 determines to use a first value as the threshold. In a case where the concession status information does not indicate that “the maximum concession is made”, the agreement determination unit 113 determines to use a second value larger than the first value, as the threshold. The agreement determination unit 113 determines to agree with the agreement candidate proposal U in a case where the utility AI obtained from the agreement candidate proposal U is larger than the determined threshold and determines not to agree in a case where the utility AI is smaller than the threshold.

In a case where it is determined to make the agreement in step S209 (Yes in step S210), step S211 is executed. In step S211, the agreement determination unit 113 transmits information indicating that the agreement candidate proposal U is agreed, to the negotiation device 20. Then, the negotiation system 1A ends the negotiation method S2.

In a case where it is determined not to agree with the agreement candidate proposal U in step S209 (No in step S210), step S212 is executed. In step S212, the agreement candidate proposal provision unit 114 generates a new agreement candidate proposal AI of which the utility AI to be obtained is smaller or the utility U to be estimated is larger, as the degree of the concession indicated by the concession status information is larger. Here, the new agreement candidate proposal AI is a counter offer for the agreement candidate proposal U most recently received. The agreement candidate proposal provision unit 114 transmits the new generated agreement candidate proposal AI, to the negotiation device 20. In a case where the concession status information is not received in step S207, the agreement candidate proposal provision unit 114 generates the new agreement candidate proposal AI without considering the concession status. As a method of generating the new agreement candidate proposal AI without considering the concession status, a well-known technique can be adopted.

Specifically, the new agreement candidate proposal AI is a proposal of which the utility AI obtained from the agreement candidate proposal AI is smaller than the utility AI obtained from the agreement candidate proposal AI most recently transmitted. It is assumed that there be a plurality of candidates having different utilities AI or utilities U, as such a new agreement candidate proposal AI. In this case, the agreement candidate proposal provision unit 114 may adopt a candidate of which the utility AI is smaller as the degree of the concession indicated by the concession status is larger, among the plurality of candidates, as the new agreement candidate proposal AI. The agreement candidate proposal provision unit 114 may adopt a candidate of which the utility U is larger as the degree of the concession indicated by the concession status is larger, among the plurality of candidates, as the new agreement candidate proposal AI. The agreement candidate proposal provision unit 114 may adopt a candidate of which the utility AI is smaller and the utility U is larger, as the degree of the concession indicated by the concession status is larger, among the plurality of candidates, as the new agreement candidate proposal AI.

For example, it is assumed that there be a first candidate and a second candidate as the candidate of the new agreement candidate proposal AI of which the utility AI is smaller than the agreement candidate proposal AI most recently transmitted. It is assumed that the second candidate have a smaller utility AI than the first candidate. In this case, in a case where the received concession status information indicates that “the maximum concession is made”, the agreement candidate proposal provision unit 114 adopts the second candidate with the smaller utility AI as the new agreement candidate proposal AI. In a case where the concession status information does not indicate that the “the maximum concession is made”, the agreement candidate proposal provision unit 114 adopts the first candidate with the larger utility AI as the new agreement candidate proposal AI.

For example, it is assumed that there be a third candidate and a fourth candidate as the candidate of the new agreement candidate proposal AI of which the utility AI is smaller than the agreement candidate proposal AI most recently transmitted. It is assumed that the fourth candidate have a larger estimated utility U than the third candidate. In this case, in a case where the received concession status information indicates that “the maximum concession is made”, the agreement candidate proposal provision unit 114 adopts the fourth candidate with the larger utility U as the new agreement candidate proposal AI. In a case where the concession status information does not indicate that the “the maximum concession is made”, the agreement candidate proposal provision unit 114 adopts the third candidate with the smaller utility U as the new agreement candidate proposal AI.

In step S213, the transmission/reception unit 211 of the negotiation device 20 receives the new agreement candidate proposal AI. Then, the negotiation device 20 repeats the processing from step S202.

### (Screen Example in Second Step S202)

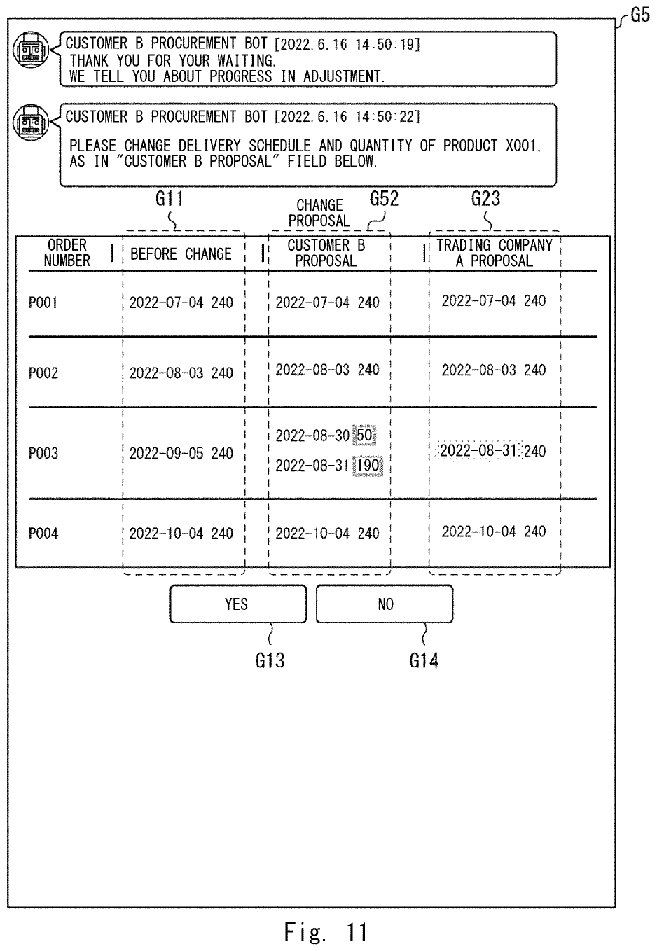

FIG. 11 is a diagram illustrating a screen example G5 including a new agreement candidate proposal AI (customer B proposal G52), presented in second step S202. Although the screen example G5 is configured substantially similarly to the screen example G1, the screen example G5 is different from the screen example G1 in that the customer B proposal G52 is included instead of the customer B proposal G12 and the trading company A proposal G23 is further included. The customer B proposal G52 is generated as a counter offer for the trading company A proposal G23, by the agreement candidate proposal provision unit 114 of the customer B bot and is a proposal having a smaller utility U than the trading company A proposal G23.

Here, an example will be described, in which, in the previous steps S205 and S206, the person in charge in the trading company A performs an operation for editing the trading company A proposal G23 and operates the operation object G26 (“approach with this content” button) without inputting the concession status information. That is, the trading company A proposal G23 is transmitted to the customer B bot without adding the concession status information, and the customer B proposal G52 that is the counter offer thereof is generated without considering the concession status. The person in charge in the trading company A has made the maximum concession for the trading company A proposal G23, and it is not possible to agree with a proposal with a utility U smaller than this. Therefore, the person in charge in the trading company A operates the operation object G14 (“No” button).

### (Screen Example in Second Step S205)

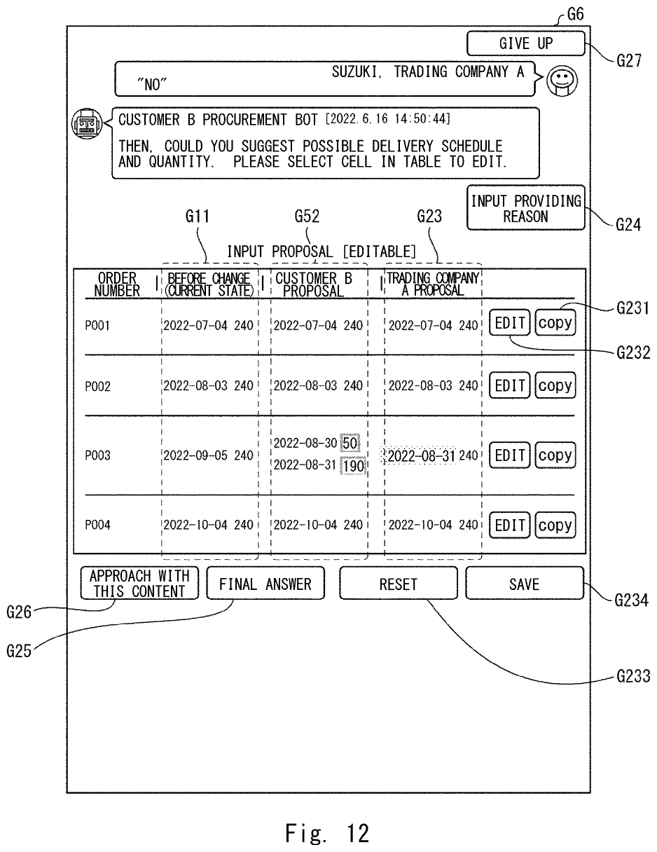

FIG. 12 is a diagram illustrating a screen example G6, on which the agreement candidate proposal U (the trading company A proposal G23) and the concession status information can be input, presented in second step S205. Although the screen example G6 is configured substantially similarly to the screen example G2 illustrated in FIG. 8, the screen example G6 is different from the screen example G2 in that the customer B proposal G52 is included instead of the customer B proposal G12. The customer B proposal G52 is as described above. As described above, since the person in charge in the trading company A has made the maximum concession for the trading company A proposal G23, the person in charge in the trading company A operates, for example, the operation object G25 (“final answer” button), as the operation for inputting the concession status information, without performing the operation for editing the trading company A proposal G23.

As a result, the trading company A proposal G23 same as the previous time and the concession status information indicating that the trading company A proposal G23 is the final proposal are transmitted to the customer B bot. In a case where the trading company A proposal G23 is not changed from the previous time, the transmission of the trading company A proposal G23 may be omitted.

As a result, in the second steps S207 to S212, the customer B bot determines whether to make an agreement, in consideration of the concession status that the trading company A proposal G23 is the final proposal. As a result, a possibility that the customer B bot agrees with the trading company A proposal G23 increases. In a case of determining not to agree, the customer B bot generates a new customer B proposal according to the concession status indicated by the concession status information. As a result, since the new customer B proposal has a smaller utility AI than the previous customer B proposal G52 and has a smaller utility AI (the utility U is larger) than a case where the concession status is not considered, there is a high possibility that the trading company A can agree with the new customer B proposal.

### Effects of Present Example Embodiment

In the present example embodiment, in addition to the configuration of the first example embodiment, a configuration is adopted in which the agreement determination unit 113 of the negotiation device 10 (the negotiation subject AI) determines whether to agree with the agreement candidate proposal U provided by the negotiation subject U, according to the concession status indicated by the concession status information. As a result, it is possible to reduce a possibility that the negotiation subject U feels that the own concession status is not considered and gives up the negotiation, with respect to the determination result regarding whether the negotiation subject AI agrees with the agreement candidate proposal U provided by the negotiation subject U. As a result, it is possible to reduce a possibility that the negotiation ends in disagreement.

In the present example embodiment, in addition to the configuration described above, a configuration is adopted in which the agreement determination unit 113 of the negotiation device 10 (the negotiation subject AI) executes the processing for determining whether to agree with the agreement candidate proposal U, based on whether the utility AI obtained from the agreement candidate proposal U is larger than the threshold and uses a smaller threshold as the degree of the concession indicated by the concession status information is larger, as the threshold. As a result, as the degree of the concession by the negotiation subject U is larger in creating the agreement candidate proposal U, a possibility increases that the negotiation subject AI agrees with the agreement candidate proposal U. As a result, it is possible to reduce a possibility that a negotiation ends in disagreement.

In the present example embodiment, in addition to the configuration described above, a configuration is adopted in which, in a case where the agreement candidate proposal provision unit 114 of the negotiation device 10 (the negotiation subject AI) does not agree with the agreement candidate proposal U, a new agreement candidate proposal AI according to the concession status indicated by the concession status information is provided to the negotiation subject U. As a result, it is possible to reduce a possibility that the negotiation subject U feels that the own concession status is not considered and gives up the negotiation, with respect to the new agreement candidate proposal AI (a counter offer) provided from the negotiation subject AI for the agreement candidate proposal U provided by the negotiation subject U. As a result, it is possible to reduce a possibility that the negotiation ends in disagreement.

In the present example embodiment, in addition to the configuration described above, a configuration is adopted in which the agreement candidate proposal provision unit 114 of the negotiation device 10 (the negotiation subject AI) provides a new agreement candidate proposal AI of which the obtained utility AI is smaller or the estimated utility U is larger, as the degree of the concession indicated by the concession status information is larger. Here, it is considered that the utility U of the negotiation subject U side is larger as the utility AI of the negotiation subject AI side is smaller. Therefore, as the degree of the concession by the negotiation subject U is larger, a possibility that the negotiation subject U can agree with the new agreement candidate proposal AI increases. As a result, it is possible to reduce a possibility that the negotiation ends in disagreement.

In the present example embodiment, in addition to the configuration described above, a configuration is adopted in which, in a case of acquiring the providing reason of the agreement candidate proposal U as the concession status information, the concession status information acquisition unit 112 of the negotiation device 10 (the negotiation subject AI) estimates the concession status according to the providing reason. As a result, since the concession status is estimated according to the providing reason that is the concession status information provided by the negotiation subject U, it is possible to more accurately estimate the concession status.

In the present example embodiment, in addition to the configuration described above, a configuration is adopted in which the negotiation device 20 used by the negotiation subject U includes the negotiation UI that receives the input of the concession status information from the negotiation subject U. As a result, since the concession status information is acquired by the input of the negotiation subject U, it is possible to appropriately make a response according to the concession status of the negotiation subject U.

In the present example embodiment, in addition to the configuration described above, a configuration is adopted in which the negotiation UI receives the input of the information indicating the providing reason of the agreement candidate proposal U or the information indicating that the agreement candidate proposal U is the final proposal, as the concession status information. As a result, the negotiation subject U can more easily input the concession status information.

In the present example embodiment, in addition to the configuration described above, a configuration is adopted in which the negotiation UI receives the input of the instruction for switching the negotiation to the negotiation with the operator, from the negotiation subject U. As a result, since there is a possibility that the agreement in the negotiation with the operator is built, a possibility that the negotiation ends in disagreement can be reduced.

In the present example embodiment, in addition to the configuration described above, a configuration is adopted in which, in a case where the instruction to continue the negotiation with the operator by the negotiation subject U is input, the negotiation UI outputs the information for recommending the input of the concession status information. As a result, even in a case where the negotiation subject U tries to switch the negotiation to the negotiation with the operator, a possibility increases that the concession status information is input and the negotiation with the negotiation subject AI is continued. As a result, since the negotiation subject AI executes the responding processing according to the concession status, a possibility that the negotiation ends in disagreement can be reduced.

### First Modified Example

In a case where the concession status information indicating that the proposal is the final proposal is input by the negotiation subject U, the negotiation system 1A described above can be modified to shift to an automatic negotiation mode for automatically continuing the negotiation. The automatic negotiation mode is a mode in which an agreement candidate proposal same as the agreement candidate proposal U to which the concession status information indicating that the agreement candidate proposal U is the final proposal is added is repeatedly provided from the negotiation subject U to the negotiation subject AI, without requiring an input by the negotiation subject U, as a new agreement candidate proposal U.

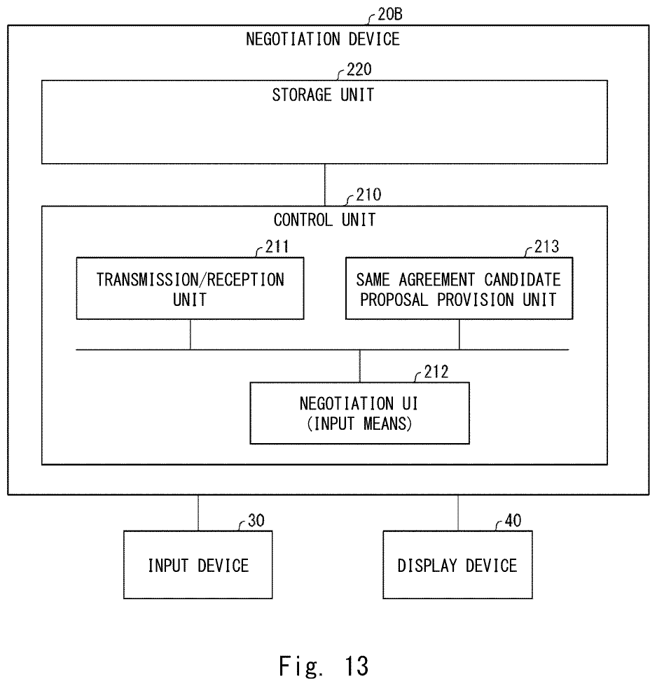

Although the negotiation system 1A according to the present modified example is configured substantially similarly to the above, the negotiation system 1A is different from the above in that a negotiation device 20B is included instead of the negotiation device 20. A configuration of the negotiation device 20B will be described with reference to FIG. 13. FIG. 13 is a block diagram illustrating the configuration of the negotiation device 20B. As illustrated in FIG. 13, the control unit 210 of the negotiation device 20B includes a same agreement candidate proposal provision unit 213, in addition to the configuration illustrated in FIG. 5. The same agreement candidate proposal provision unit 213 is an example of a configuration that achieves same agreement candidate proposal provision means described in claims. In a case where the concession status information indicates that the agreement candidate proposal U is the final proposal and the negotiation subject U does not agree with the agreement candidate proposal AI for that, the same agreement candidate proposal provision unit 213 determines to shift to the automatic negotiation mode. In the automatic negotiation mode, the same agreement candidate proposal provision unit 213 provides an agreement candidate proposal same as the agreement candidate proposal U to which the concession status information indicating that the agreement candidate proposal U is the final proposal is added, to the agreement candidate proposal acquisition unit 111 of the negotiation device 10, as a new agreement candidate proposal U (a counter offer).

As a result, the new agreement candidate proposal U acquired by the agreement candidate proposal acquisition unit 111 of the negotiation device 10 is the agreement candidate proposal same as the agreement candidate proposal U, that has already been received, to which the concession status information indicating that the agreement candidate proposal U is the final proposal is added. In a case of disagreement with the new agreement candidate proposal U, the agreement candidate proposal provision unit 114 provides a new agreement candidate proposal AI with a smaller utility AI than the previous agreement candidate proposal AI, to the negotiation subject U.

In this case, in the negotiation method S2 illustrated in FIG. 6, after receiving the input of the agreement candidate proposal U and the concession status information indicating that the agreement candidate proposal U is the final proposal in N-th (N is integer of one or more) step S205, the negotiation system 1A shifts to the automatic negotiation mode and executes subsequent steps. Thereafter, the negotiation device 20 omits (N+1)th and subsequent steps S205 (the input of the new agreement candidate proposal U), and in the subsequent step S206, the same agreement candidate proposal provision unit 213 transmits the agreement candidate proposal U same as the previous one to the negotiation device 10 as a new agreement candidate proposal. The negotiation device 10 operates with reference to the agreement candidate proposal U acquired in N-th step S207 and the concession status information, in (N+1)-th and subsequent steps S207 to S212.

As a result, for example, in the screen example G5 illustrated in FIG. 11, (1) once the person in charge in the trading company A operates the operation object G14 (“No” button), (2) the trading company A proposal G23 same as the previous one is automatically transmitted to the negotiation device 10 without displaying the screen example G6 (the input screen of the agreement candidate proposal U), and (3) the new customer B proposal having a smaller utility AI (a larger utility U) than the previous customer B proposal G52 is displayed. Then, (1) to (3) are repeated. A repetition end condition may be that the negotiation subject U agrees (the operation object G13 is operated) or the number of times of repetition reaches a predetermined number of times, but is not limited to these.

According to the present modified example, in a case where the negotiation subject U makes a maximum concession, it is possible to continue the negotiation so as to obtain the concessions by the negotiation subject AI in a stepwise manner, without inputting the new agreement candidate proposal U. As a result, it is possible to reduce a possibility that the negotiation ends in disagreement.

### Second Modified Example

An example has been described in which, in the automatic negotiation mode in the first modified example, the negotiation device 20 used by the negotiation subject U transmits the same agreement candidate proposal U as the agreement candidate proposal U that has already been transmitted as the final proposal, to the negotiation device 10, as the new agreement candidate proposal U. By modifying this, in the automatic negotiation mode, the negotiation device 10 may acquire the agreement candidate proposal U that has already been received as the final proposal, as the agreement candidate proposal U and operate, without new reception from the negotiation device 20.

The negotiation system 1A according to the present modified example does not need to include the negotiation device 20B and includes the negotiation device 20. In the present modified example, the agreement candidate proposal acquisition unit 111 of the negotiation device 10 is modified as follows. In a case where the concession status information indicates that the agreement candidate proposal U is the final proposal and the negotiation subject U does not agree with the agreement candidate proposal AI for that, the agreement candidate proposal acquisition unit 111 acquires the agreement candidate proposal same as the agreement candidate proposal U to which the concession status information indicating that the agreement candidate proposal U is the final proposal, as the agreement candidate proposal U.

In this case, in the negotiation method S2 illustrated in FIG. 6, after receiving the input of the agreement candidate proposal U and the concession status information indicating that the agreement candidate proposal U is the final proposal in N-th (N is integer of one or more) step S205, the negotiation system 1A shifts to the automatic negotiation mode and executes subsequent steps. Thereafter, the negotiation device 20 transmits information indicating disagreement with the agreement candidate proposal AI to the negotiation device 10, instead of executing (N+1)-th and subsequent steps S205 and S206. The negotiation device 10 operates with reference to the agreement candidate proposal U acquired in N-th step S207 and the concession status information, in (N+1)-th and subsequent steps S207 to S212.

A transition of a screen example in a case of such a modification is as described in the first modified example. The present modified example achieves effects similar to the first modified example.

### Third Modified Example

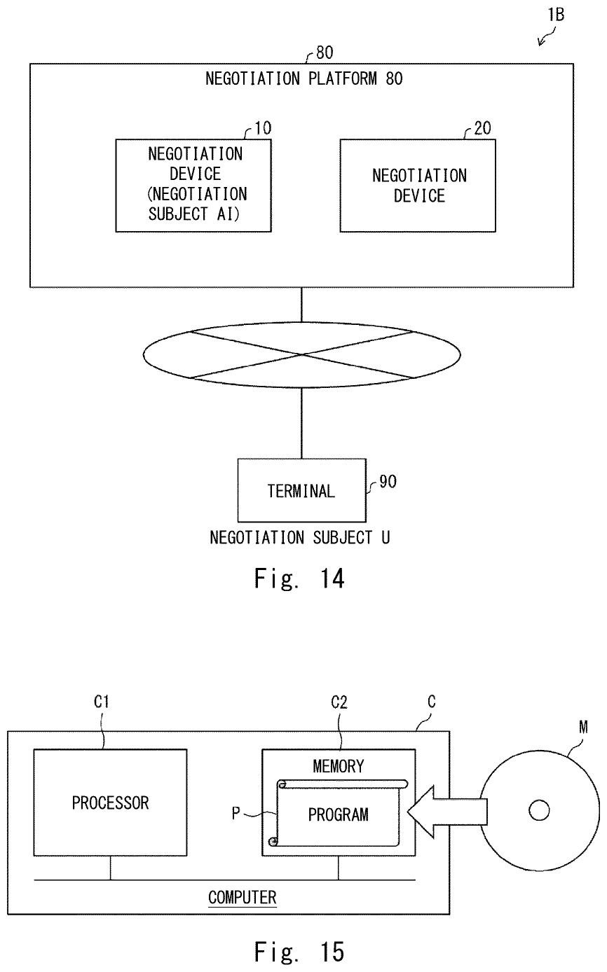

In the second example embodiment described above, the negotiation device 10 and the negotiation device 20 can be modified to be included in a negotiation platform 80, instead of being configured as separate devices connected via a network. FIG. 14 is a block diagram illustrating a configuration of a negotiation system 1B according to the present modified example. As illustrated in FIG. 14, the negotiation system 1B includes the negotiation platform 80 and a terminal 90. The negotiation platform 80 and the terminal 90 are communicatively connected via the network. The negotiation platform 80 includes the negotiation device 10 and the negotiation device 20.

The negotiation platform 80 includes, for example, one or a plurality of computers and achieves each function of the negotiation device 10 and the negotiation device 20, by executing a program stored in a memory. The negotiation device 20 functions based on an operation of the terminal 90 used by the negotiation subject U. The input device 30 and the display device 40 are connected to or built in the terminal 90. The negotiation device 10 and the negotiation device 20 may provide/acquire the agreement candidate proposal and the concession status information, by sharing the agreement candidate proposal and the concession status information via the memory, instead of transmitting/receiving the agreement candidate proposal and the concession status information via the network. The present modified example achieves effects similar to the second example embodiment described above.

### Other Modified Examples

In the second example embodiment, description has been made as assuming that the negotiation device 20 is a device used by the negotiation subject U that is a person or an organization to negotiate with another negotiation subject. The negotiation device 20 is not limited to this, and a device that functions as a negotiation subject that negotiates with the another negotiation subject without depending on a user's operation may be applied, as the negotiation device 20. In this case, it is sufficient for the negotiation device 20 to execute processing for generating the concession status information and the agreement candidate proposal U instead of acquiring the concession status information and the agreement candidate proposal U by the input of the user.

### Example of Achievement by Software

Some or all of the functions of the negotiation system 1 and the negotiation devices 10 and 20 (hereinafter, referred to as a “device”) may be achieved by hardware such as an integrated circuit (an IC chip) or may be achieved by software.

In the latter case, the device is achieved by, for example, a computer that executes an instruction of a program that is software for achieving each function. An example of such a computer (hereinafter, referred to as a computer C) is illustrated in FIG. 15. The computer C includes at least one processor Cl and at least one memory C2. A program P for operating the computer C as the device is recorded in the memory C2. In the computer C, the processor C1 reads the program P from the memory C2 and executes the program P to achieve each function of the device.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, or a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Matter 1

The present invention is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present invention.

### Supplementary Matter 2

Some or all the above-described example embodiments may be described as follows. However, the present invention is not limited to the following aspects.

### Supplementary Note 1

A negotiation system including:
agreement candidate proposal acquisition means for acquiring a first agreement candidate proposal provided from a negotiation subject, in a negotiation with the negotiation subject that is a negotiation partner;
concession status information acquisition means for acquiring concession status information indicating a concession status of the negotiation subject in the first agreement candidate proposal; and
response means for executing processing for responding to the first agreement candidate proposal, according to the concession status indicated by the concession status information.

### Supplementary Note 2

The negotiation system according to supplementary note 1, in which the responding processing includes processing for determining whether to agree with the first agreement candidate proposal, according to the concession status indicated by the concession status information.

### Supplementary Note 3

The negotiation system according to supplementary note 2, in which the responding processing includes processing for providing a second agreement candidate proposal according to the concession status indicated by the concession status information, to the negotiation subject, in a case where the first agreement candidate proposal is not agreed to.

### Supplementary Note 4

The negotiation system according to supplementary note 2,
in which the response means
executes processing for determining whether to agree with the first agreement candidate proposal, based on whether a utility obtained from the first agreement candidate proposal is larger than a threshold, and uses a smaller threshold as a degree of a concession indicated by the concession status information is larger, as the threshold.

### Supplementary Note 5

The negotiation system according to supplementary note 3,
in which the response means
provides the second agreement candidate proposal of which a utility to be obtained is smaller or an estimated utility of the negotiation subject side is larger, as a degree of a concession indicated by the concession status information is larger.

### Supplementary Note 6

The negotiation system according to any one of supplementary notes 1 to 5, in which in a case of acquiring a providing reason of the first agreement candidate proposal, as the concession status information, the concession status information acquisition means estimates the concession status according to the providing reason.

### Supplementary Note 7

The negotiation system according to supplementary note 3, further including:
same agreement candidate proposal provision means for providing an agreement candidate proposal same as the first agreement candidate proposal to the agreement candidate proposal acquisition means as a new first agreement candidate proposal,
in a case where the concession status information indicates that the first agreement candidate proposal is a final proposal and the negotiation subject does not agree with the second agreement candidate proposal.

### Supplementary Note 8

The negotiation system according to supplementary note 3,
in which in a case where the concession status information indicates that the first agreement candidate proposal is a final proposal and the negotiation subject does not agree with the second agreement candidate proposal,
the agreement candidate proposal acquisition means acquires an agreement candidate proposal same as the first agreement candidate proposal, as a new first agreement candidate proposal.

### Supplementary Note 9

The negotiation system according to any one of supplementary notes 1 to 8, further including input means for receiving an input of the concession status information from the negotiation subject.

### Supplementary Note 10

The negotiation system according to supplementary note 9, in which the input means receives an input of information indicating the providing reason of the first agreement candidate proposal or information indicating that the first agreement candidate proposal is the final proposal, as the concession status information.

### Supplementary Note 11

The negotiation system according to supplementary note 9,
in which the input means
receives an input of an instruction to switch the negotiation to a negotiation with an operator, from the negotiation subject.

### Supplementary Note 12

The negotiation system according to supplementary note 11,
in which the input means
outputs information for recommending to input the concession status information and to continue the negotiation, in a case where the instruction is input by the negotiation subject.

### Supplementary Note 13

A negotiation method executed by one or more processors, the method including:
acquiring a first agreement candidate proposal provided from a negotiation subject, in a negotiation with the negotiation subject that is a negotiation partner;
acquiring concession status information indicating a concession status of the negotiation subject in the first agreement candidate proposal; and
executing processing for responding to the first agreement candidate proposal, according to the concession status indicated by the concession status information.

### Supplementary Note 14

A program for causing a computer to function as:
agreement candidate proposal acquisition means for acquiring a first agreement candidate proposal provided from a negotiation subject, in a negotiation with the negotiation subject that is a negotiation partner;
concession status information acquisition means for acquiring concession status information indicating a concession status of the negotiation subject in the first agreement candidate proposal; and
response means for executing processing for responding to the first agreement candidate proposal, according to the concession status indicated by the concession status information.

### Supplementary Matter 3

Some or all the above-described example embodiments may be described as follows.

A negotiation system including at least one processor, and the processor executes
agreement candidate proposal acquisition processing for acquiring a first agreement candidate proposal provided from a negotiation subject, in a negotiation with the negotiation subject that is a negotiation partner,
concession status information acquisition processing for acquiring concession status information indicating a concession status of the negotiation subject in the first agreement candidate proposal, and
response processing for executing processing for responding to the first agreement candidate proposal, according to the concession status indicated by the concession status information.

This negotiation system may further include a memory, and a program for causing the processor to execute the agreement candidate proposal acquisition processing, the concession status information acquisition processing, and the response processing may be stored in the memory. This program may be recorded in a computer-readable non-transitory tangible recording medium.

### REFERENCE SIGNS LIST

1, 1A, 1B negotiation system
10, 20 negotiation device
110, 210 control unit
120, 220 storage unit
11, 111 agreement candidate acquisition unit
12, 112 concession status information acquisition unit
13 response unit
113 agreement determination unit
114 agreement candidate provision unit
211 transmission/reception unit
212 negotiation UI
30 input device
40 display device
80 negotiation platform
90 terminal
C1 processor
C2 memory

What is claimed is:

1. A negotiation system comprising:
a memory configured to store instructions: and a processor configured to execute the instructions to do:
agreement candidate proposal acquisition processing that acquires a first agreement candidate proposal provided from a negotiation subject, in a negotiation with the negotiation subject that is a negotiation partner;
concession status information acquisition processing that acquires concession status information indicating a concession status of the negotiation subject in the first agreement candidate proposal; and
response processing that executes processing for responding to the first agreement candidate proposal, according to the concession status indicated by the concession status information.

2. The negotiation system according to claim 1, wherein the response processing includes processing that determines whether to agree with the first agreement candidate proposal, according to the concession status indicated by the concession status information.

3. The negotiation system according to claim 2, wherein the response processing includes processing that provides a second agreement candidate proposal according to the concession status indicated by the concession status information, to the negotiation subject, in a case where the first agreement candidate proposal is not agreed.

4. The negotiation system according to claim 2,
wherein the response processing
executes processing to determine whether to agree with the first agreement candidate proposal, based on whether a utility obtained from the first agreement candidate proposal is larger than a threshold, and
uses a smaller threshold as a degree of a concession indicated by the concession status information is larger, as the threshold.

5. The negotiation system according to claim 3,
wherein the response processing
provides the second agreement candidate proposal of which a utility to be obtained is smaller or an estimated utility of the negotiation subject side is larger, as a degree of a concession indicated by the concession status information is larger.

6. The negotiation system according to claim 1, wherein in a case of acquiring a providing reason of the first agreement candidate proposal, as the concession status information, the concession status information acquisition processing estimates the concession status according to the providing reason.

7. The negotiation system according to claim 3, further comprising:
same agreement candidate proposal provision processing that provides an agreement candidate proposal same as the first agreement candidate proposal to the agreement candidate proposal acquisition processing as a new first agreement candidate proposal,
in a case where the concession status information indicates that the first agreement candidate proposal is a final proposal and the negotiation subject does not agree with the second agreement candidate proposal.

8. The negotiation system according to claim 3,
wherein in a case where the concession status information indicates that the first agreement candidate proposal is a final proposal and the negotiation subject does not agree with the second agreement candidate proposal,
the agreement candidate proposal acquisition processing acquires an agreement candidate proposal same as the first agreement candidate proposal, as a new first agreement candidate proposal.

9. The negotiation system according to claim 1, further comprising input processing that receives an input of the concession status information from the negotiation subject.

10. The negotiation system according to claim 9, wherein the input processing receives an input of information indicating the providing reason of the first agreement candidate proposal or information indicating that the first agreement candidate proposal is the final proposal, as the concession status information.

11. The negotiation system according to claim 9,
wherein the input processing
receives an input of an instruction to switch the negotiation to a negotiation with an operator, from the negotiation subject.

12. The negotiation system according to claim 11,
wherein the input processing
outputs information for recommending to input the concession status information and to continue the negotiation, in a case where the instruction is input by the negotiation subject.

13. A negotiation method executed by one or more processors, the method comprising:
acquiring a first agreement candidate proposal provided from a negotiation subject, in a negotiation with the negotiation subject that is a negotiation partner;
acquiring concession status information indicating a concession status of the negotiation subject in the first agreement candidate proposal; and
executing processing for responding to the first agreement candidate proposal, according to the concession status indicated by the concession status information.

14. A non-transitory computer readable medium storing a program for causing a computer to function as:
agreement candidate proposal acquisition means for acquiring a first agreement candidate proposal provided from a negotiation subject, in a negotiation with the negotiation subject that is a negotiation partner;
concession status information acquisition means for acquiring concession status information indicating a concession status of the negotiation subject in the first agreement candidate proposal; and
response means for executing processing for responding to the first agreement candidate proposal, according to the concession status indicated by the concession status information.

15. The negotiation method according to claim 13, wherein the executing processing for responding includes processing that determines whether to agree with the first agreement candidate proposal, according to the concession status indicated by the concession status information.

16. The negotiation method according to claim 15, wherein the executing processing for responding includes processing that provides a second agreement candidate proposal according to the concession status indicated by the concession status information, to the negotiation subject, in a case where the first agreement candidate proposal is not agreed.

17. The negotiation method according to claim 15,
wherein the executing processing for responding
executes processing that determines whether to agree with the first agreement candidate proposal, based on whether a utility obtained from the first agreement candidate proposal is larger than a threshold, and
uses a smaller threshold as a degree of a concession indicated by the concession status information is larger, as the threshold.

18. The negotiation method according to claim 16,
wherein the executing processing for responding
provides the second agreement candidate proposal of which a utility to be obtained is smaller or an estimated utility of the negotiation subject side is larger, as a degree of a concession indicated by the concession status information is larger.

19. The negotiation method according to claim 13, wherein in a case of acquiring a providing reason of the first agreement candidate proposal, as the concession status information, the acquiring concession status information estimates the concession status according to the providing reason.

20. The negotiation method according to claim 16, further comprising:
providing same agreement candidate proposal that provides an agreement candidate proposal same as the first agreement candidate proposal to the acquiring agreement candidate proposal as a new first agreement candidate proposal,
in a case where the concession status information indicates that the first agreement candidate proposal is a final proposal and the negotiation subject does not agree with the second agreement candidate proposal.
